(19) United States
(12) Patent Application Publication
(10) Pub. No.: US 2003/0002912 A1
(43) Pub. Date: Jan. 2, 2003

(54) Wax applicator

(76) Inventor: David Morpeth, Auckland (NZ)

Correspondence Address: JACOBSON HOLMAN PLLC, 400 SEVENTH STREET, N.W., WASHINGTON, DC, 20004, US

(21) Appl. No.: 10/159,986

(22) Filed: Jun. 3, 2002

(30) Foreign Application Priority Data
Jun. 1, 2001 (NZ) 512166

(51) Int. Cl. B05C 21/00

(52) U.S. Cl. 401/220; 401/208

(57) ABSTRACT

A wax applicator having a first container to contain wax and an applicator head for receiving the wax from the first container, and a roller for transferring the wax to a surface which may include a lid.

The present invention relates to a wax applicator.

It is well known in the art that one effective way of removing hair from the body is to apply a warm wax or other wax like substance to the skin using a spatula or other similar means. The wax is then removed from the skin by using a cotton strip or other piece of cotton that has been placed on the wax. The cotton strip is then pulled back. At the time as the wax is being removed it also removes the hair from the roots, as the hairs are now embedded in the wax.

The disadvantage of using a warm or cold wax using a spatula is that the wax can get messy. This is because the wax is a thick liquid and becomes tacky and stringy on delivering it from the pot to the body. There is also the difficulty of spreading the wax to an ideal thickness on the body which again can get messy. The wax also has a tendency of getting stuck to the clothes and hands of the person applying the wax.

Accordingly, means have been devised to contain the wax within a container that can be heated, either internally or externally. The application of the wax is then made via an attachment to the container that holds the wax. This ensures that the application of the wax does not have to be handled outside of the container in which the wax was heated.

Reference is made to U.S. Pat. No. 6,076,984, which incorporates a container and application means via a roller to transfer heated wax from the container to the surface of the skin. The full content of U.S. Pat. No. 6,076,984 is herein incorporated by way of reference.

However, a disadvantage of using a roller to apply wax to the skin is that as the contours of the body can be uneven, and in some places concave, the wax is not evenly distributed nor does the wax reach these concave areas of the body. Such as for example the arm pit, where the edges surrounding the arm pit become coated with the wax.

A further disadvantage of a roller is that the area to which the roller applies wax cannot be reduced to an area smaller than the area of the roller. Therefore to apply wax to these small areas the roller must be carefully manoeuvred to apply wax to the area in question. Generally in such circumstances there is a wastage of wax and wax being applied to inappropriate areas. Such as for example facial hair along the top lip of a person where the wax can inadvertently be applied to the lip. Also where wax is being applied to the eye lid area, care must be taken to ensure no wax is also applied to the eye or eye lashes.

Other problems with wax roller applicators is the build-up of wax around the sides of the roller and in between the space between the roller and edge of the applicator. Another problem is that the edges of a flat sided roller can catch on the skin's surface and prevents the roller from turning rendering the process of applying the wax as ineffectual.

Further problems with wax roller applicators is that they are often badly designed in terms of the ergonomics of the container. An example of bad ergonomic design is that when an ordinary applicator is used for applying wax to the leg, where the user is sitting, the applicator must be placed at right angles to the leg, especially around the base of the leg. Thus the user needs to have a very long arm or has to manoeuvre the applicator in such a way to ensure the wax is applied which can be very uncomfortable.

It is therefore an object of the present invention to provide an ergonomically designed wax applicator that allows wax to be applied, whether the surface of the skin is uneven or not, to aid in the removal of body hair and/or at least to provide the public with a useful choice.

In a first aspect the present invention consists in a wax applicator comprising or including

a first container to contain wax or similar substance,

an applicator head for receiving said wax from said first container, and

a roller for transferring said wax from said applicator head to apply the wax to a surface, and

optionally a lid,

wherein said roller is rotatably mounted, whether removable or not, with said applicator head, and

wherein said applicator head is able to be attached to said first container either by screw or snap engagement, and

wherein said applicator head has at least one longitudinal edge the said edge extending parallel with the surface of the roller on at least one side of the applicator head.

Preferably said first container is provided with snap engagement features or is screw threaded at one end, for attachment of said applicator head.

Preferably said applicator head is provided with receiving means for receiving said roller.

Preferably said receiving means is provided with shoulders configured to the shape of said roller head.

Preferably said applicator head has mounts to receive said roller, said mounts being recesses.

Preferably said roller is provided with an axle defining upstands capable of engaging with said mounts that are snap engageable with said axle defining upstand.

Preferably said applicator head is provided with a hole in which to receive said wax from said first container.

Preferably said applicator head is provided with a second containment region for receiving said wax from said first container immediately prior to being applied to said surface via said roller.

In a further aspect the present invention consists in an applicator assembly (“applicator”) suitable for applying a liquid to a surface, said applicator comprising or including

a container containing or to contain the liquid, said container having an outlet,

an applicator head engaged or engageable with said container to receive liquid from said container via said outlet,

a roller at least in part in or rotatably locatable in said applicator head to both receive liquid received by the applicator head from the container and to transfer the liquid onto a surface on which the liquid coated roller is to be rolled,

wherein the applicator head and the roller subassembly has such asymmetry such that the rolling direction is better in one sense than the other when the container of the applicator, as a result of the applicator disposition relative to the surface, is proximate to said surface to which the liquid is to be applied.

Preferably said applicator head is engaged to said container about said outlet by a screw or snap interengagement.

Preferably said roller has its rolling surface substantially cylindrically formed.

Preferably said roller includes convex ends.

Preferably the ends of the roller are closely associated with the applicator head so as to prefer uptake of the liquid from within the applicator head on the rolling surface of the roller.

Preferably the rolling surface of the roller is in close proximity of an edge, lip or other defined periphery of the applicator head within which said roller is located so as to restrict presentation of liquid on the rolling surface to a desired amount.

Preferably said applicator head is asymmetric about an axis transverse to the rolling axis of said roller.

Preferably said applicator is assembled and includes said liquid.

Preferably said outlet has a removable seal.

Preferably said applicator and roller subassembly has a closure cap.

Preferably said liquid (whether liquid at ambient temperatures or not) is a depilatory composition.

In yet a further aspect the present invention consists in an applicator head suitable for applying a liquid to a skin surface, said head comprising or including

an attachment part capable of fitting to a container,

a receiving opening for receiving a roller,

a containment region having a hole into said attachment part to receive a liquid from a container and a surface substantially corresponding to the application area of said roller, and

a roller located at least in part in said receiving opening to receive liquid received by said containment region and by rotation of said roller transfers the liquid onto a skin surface,

wherein said roller when rolled in one direction, rather than the other, better enables substantially more of the head to be in contact with the skin.

Preferably said attachment part is engaged to said container by snap or screw engagement.

In another aspect the present invention relates to any part of the applicator substantially as hereinafter described with or without reference to any one or more of the accompanying drawings and/or which includes apparatus as previously defined.

As used herein the term “first container” refers to and includes any container capable of acting as a wax reservoir such as for example a container, bottle, flask or other similar container.

As used herein the terms “wax” or “liquid” refers to and includes any depilatory substance, gel, gel like fluids or creams that can be applied to the skin to remove the hair, this includes such depilatory substances based on sugars, resins and beeswaxes.

One preferred form of the present invention will now be described with reference to the accompanying drawings in which;

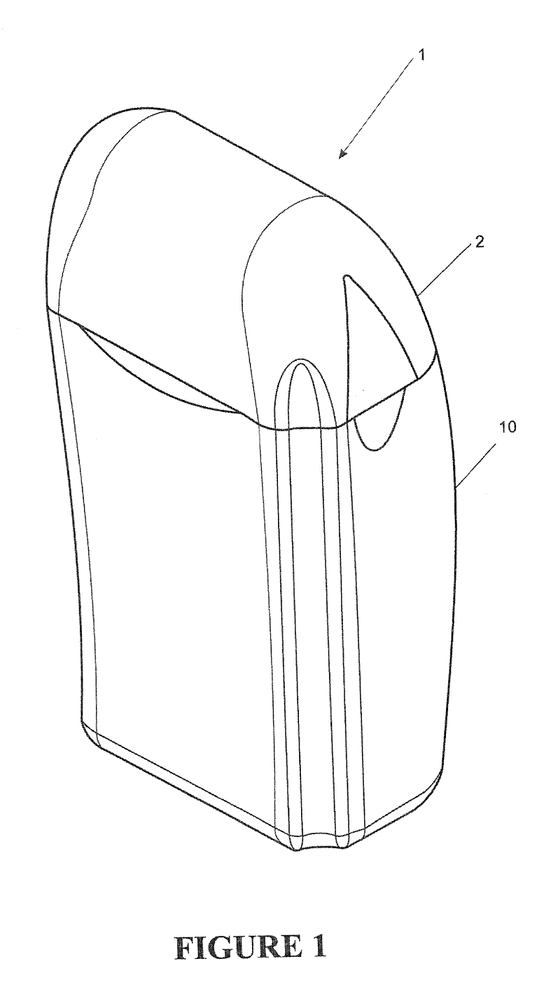

FIG. 1 is a preferred form of the wax hair removal applicator with the lid on.

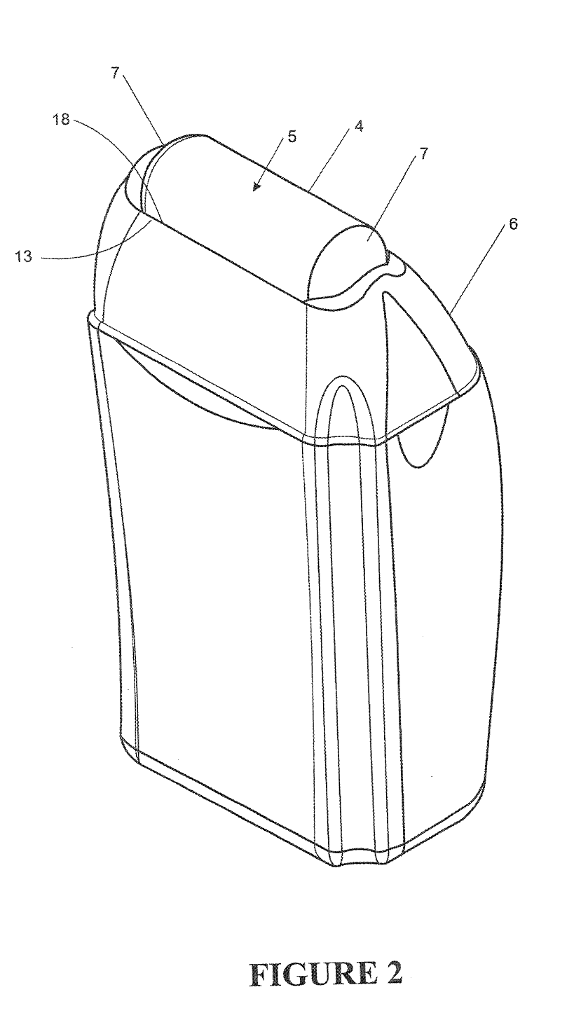

FIG. 2 is a perspective view of the wax hair removal applicator with the lid off.

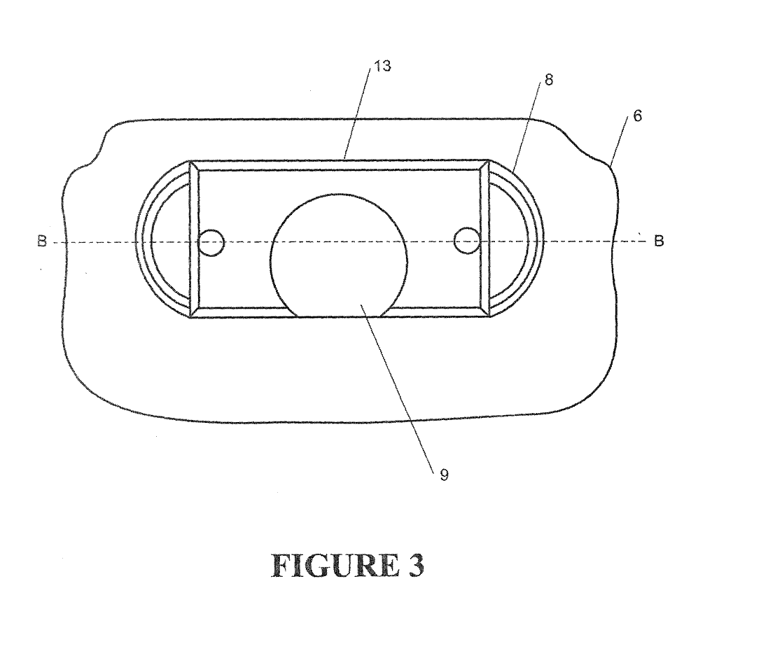

FIG. 3 is a top view of the applicator head with the roller removed.

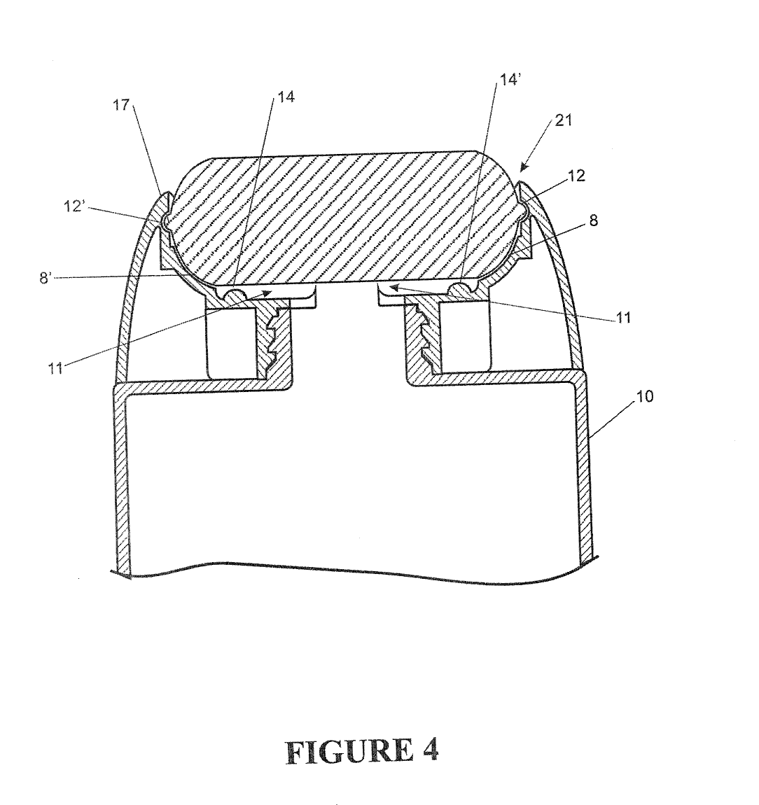

FIG. 4 is a cross section of FIG. 3 through BB,

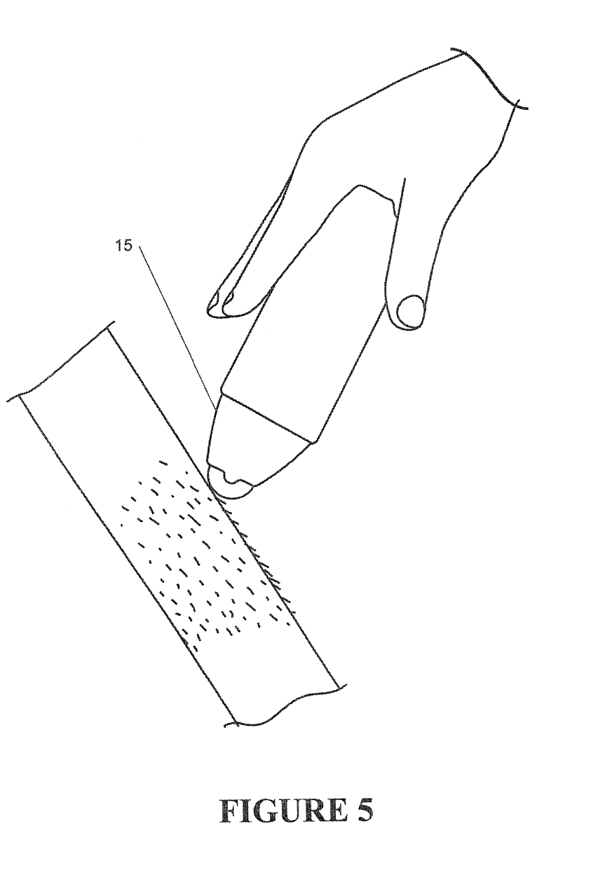

FIG. 5 is a view of the wax hair removal applicator in use and

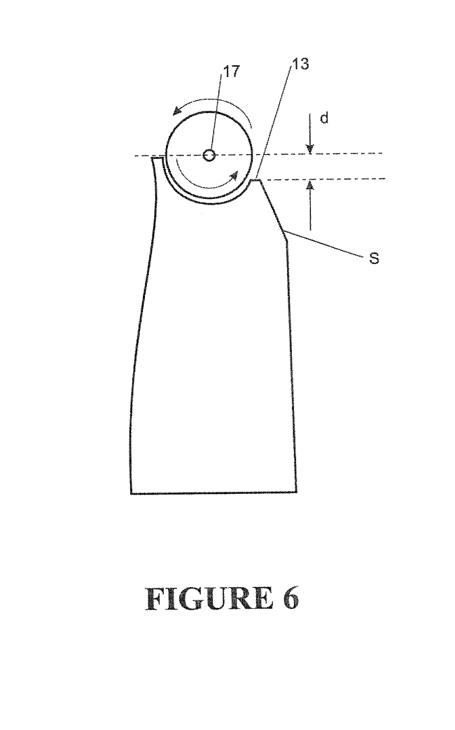

FIG. 6 is a side view illustrating the position of the edge of the applicator head relative to the axis of the roller.

Preferably one form of the wax applicator 1 is as shown in FIG. 1. The lid 2 can easily be removed from the applicator head 6 by simply applying pressure along the top of the lid and uplifting the lid by the hand. The roller 4 is then exposed and ready for use.

The roller 4 has a main surface area 5 which can receive the wax from a containment region 11 and is located into the receiving area 21 of the applicator head. The roller 4 also has regions 7 located at either end of the roller which receives a greatly reduced amount of wax due to the shoulders 8 and partitions 14 preventing a substantial amount of wax moving into the area between the shoulders 8 and the regions 7. The amount being approximately 50%. The shoulders 8 of the applicator head are configured to a shape to receive the roller. Due to region 7 being of a smaller area than the main surface area 5 and receiving a greatly reduced amount of wax, enables the provision of a narrow strip of wax to be applied to these sensitive areas of the body for hair removal. Such areas include the underarm or upper lip.

The applicator head is also provided with an opening 9 that allows the heated wax to flow from the container 10 into the containment region. Once the wax is in the containment region it can be applied to a surface via the roller.

The roller is preferably mounted inside the applicator head about the rollers stub axis 17 to allow free rotation. This rotation is achieved by the stub axis fitting into the recesses 12 of the receiving region of the applicator head and this allows the stub axis to rotate freely. The roller can be pushed into the recesses and alternatively popped out again for easy cleaning if required, however generally the roller can not be popped out.

An opening space 18 is provided between the roller and the top lip 13 of the applicator head. This opening space provides the opening through which the wax can be applied onto a surface. This opening space allows the wax to be applied in an even continuous strip as the top lip causes excess wax to be retained and the opening space determines the amount of wax that can be applied. The advantage of this is that through the opening 18 which is useful for such body areas as the leg.

FIG. 5 shows the wax applicator in use where a person holds the container either at an angle to the surface as shown or alternatively the applicator head can be flush with the surface. This will depend on how the user wishes to use the applicator. The wax is then applied to the surface, usually over hairs that become coated, a cotton strip is then placed on the wax covered area pressed down and as the cotton strip is removed this removes the cold wax which now has the hair embedded into surface allowing the hair to be lifted out.

With reference to FIG. 6 which is a side view of the applicator it can be seen that the edge 13 of the opening of the applicator head 6 is located on the body side of the applicator to the position at which the rotational axis of the roller is located relative to the body. Such a displacement may be by, for example, a distance “D”.

The point at which the skin can first make contact with the surface of the roller as the roller rotates, is at the edge 13 of the opening. By having the axis 17 placed above the edge 13, as the roller rotates, this allows the surface of the roller at the edge 13 to advance in a direction with a component of movement outwardly. When the surface “S” of the applicator is placed flush against the skin, and the device is moved along the skin, an application of wax can occur to the skin which provides a thin but continuous stream of wax. In the most preferred form the surface “S”, is of a shape which, for example, in side view as shown in FIG. 6, angles towards the surface of the roller in the direction approaching the edge of the opening 13.

1. A wax applicator comprising or including
a first container to contain wax or similar substance,
an applicator head for receiving said wax from said first container, and
a roller for transferring said wax from said applicator head to apply the wax to a surface, and
optionally a lid,
wherein said roller is rotatably mounted, whether removable or not, with said applicator head, and
wherein said applicator head is able to be attached to said first container either by screw or snap engagement, and
wherein said applicator head has at least one longitudinal edge the said edge extending parallel with the surface of the roller on at least one side of the applicator head.

2. A wax applicator as claimed in claim 1 wherein said first container is provided with snap engagement features or is screw threaded at one end, for attachment of said applicator head.

3. A wax applicator as claimed in claims 1 or 2 wherein said applicator head is provided with receiving means for receiving said roller.

4. A wax applicator as claimed in claim 3 wherein said receiving means is provided with shoulders configured to the shape of said roller head.

5. A wax applicator as claimed in any one of claims 3 or 4 wherein said applicator head has mounts to receive said roller, said mounts being recesses.

6. A wax applicator as claimed in any one of claims 1 to 5 wherein said roller is provided with an axle defining upstands capable of engaging with said mounts that are snap engageable with said axle defining upstand.

7. A wax applicator as claimed in any one of claims 1 to 6 wherein said applicator head is provided with a hole in which to receive said wax from said first container.

8. A wax applicator as claimed in any one of claims 1 to 7 wherein said applicator head is provided with a second containment region for receiving said wax from said first container immediately prior to being applied to said surface via said roller.

9. An applicator assembly (“applicator”) suitable for applying a liquid to a surface, said applicator comprising or including
a container containing or to contain the liquid, said container having an outlet,
an applicator head engaged or engageable with said container to receive liquid from said container via said outlet,
a roller at least in part in or rotatably locatable in said applicator head to both receive liquid received by the applicator head from the container and to transfer the liquid onto a surface on which the liquid coated roller is to be rolled,
wherein the applicator head and the roller subassembly has such asymmetry such that the rolling direction is better in one sense than the other when the container of the applicator, as a result of the applicator disposition relative to the surface, is proximate to said surface to which the liquid is to be applied.

10. An applicator as claimed in claim 9 wherein said applicator head is engaged to said container about said outlet by a screw or snap interengagement.

11. An applicator as claimed in claim 9 or 10 wherein said roller has its rolling surface substantially cylindrically formed.

12. An applicator as claimed in any one of claims 9 to 11 wherein said roller includes convex ends.

13. An applicator as claimed in any one of claims 9 to 12 wherein the ends of the roller are closely associated with the applicator head so as to prefer uptake of the liquid from within the applicator head on the rolling surface of the roller.

14. An applicator as claimed in any one of claims 9 to 13 wherein the rolling surface of the roller is in close proximity of an edge, lip or other defined periphery of the applicator head within which said roller is located so as to restrict presentation of liquid on the rolling surface to a desired amount.

15. An applicator as claimed in any one of claims 9 to 14 wherein said applicator head is asymmetric about an axis transverse to the rolling axis of said roller.

16. An applicator of any one of claims 9 to 15 wherein said applicator is assembled and includes said liquid.

17. An applicator of any one of claims 9 to 16 wherein said outlet has a removable seal.

18. An applicator of any one of claims 9 to 17 wherein said applicator and roller subassembly has a closure cap.

19. An applicator of any one of claims 9 to 18 wherein said liquid (whether liquid at ambient temperatures or not) is a depilatory composition.

20. An applicator head suitable for applying a liquid to a skin surface, said head comprising or including
an attachment part capable of fitting to a container,
a receiving opening for receiving a roller,
a containment region having a hole into said attachment part to receive a liquid from a container and a surface substantially corresponding to the application area of said roller, and
a roller located at least in part in said receiving opening to receive liquid received by said containment region and by rotation of said roller transfers the liquid onto a skin surface,
wherein said roller when rolled in one direction, rather than the other, better enables substantially more of the head to be in contact with the skin.

22. An applicator head as claimed in claim 20 wherein said attachment part is engaged to said container by snap or screw engagement.

23. Any part of the applicator substantially as hereinbefore described with or without reference to any one or more of the accompanying drawings and/or which includes apparatus as previously defined.
